(19) United States
(12) Patent Application Publication
(10) Pub. No.: US 2008/0118163 A1
(43) Pub. Date: May 22, 2008

(54) METHODS AND APPARATUSES FOR MOTION DETECTION

(76) Inventors: Ching-Hua Chang, Taipei Hsien (TW); Po-Wei Chao, Taipei Hsien (TW); Hsin-Ying Ou, Hsin-Chu City (TW); Wen-Tsai Liao, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/845,755

(22) Filed: Aug. 27, 2007

(30) Foreign Application Priority Data
Nov. 16, 2006 (TW) 095142446

(51) Int. Cl. G06K 9/36

(52) U.S. Cl. 382/236

(57) ABSTRACT

Methods and apparatuses for motion detection are disclosed. One proposed method includes: detecting at least a field to generate a plurality of statistical values; determining at least one threshold value according to the plurality of statistical values; and performing motion detection on pixel positions of a subsequent field according to the determined threshold value.

### BACKGROUND OF THE INVENTION

1. Field of the Invention

The present invention relates to an image process technology, and more particularly, to motion detection methods of a threshold value used for dynamically adjusting, and related apparatuses.

2. Description of the Prior Art

Motion detection is very important for many image processing calculations. Typically, the motion detection can be divided into two categories, i.e. field motion detection and frame motion detection. Taking the field motion detection as an example, the prior art typically detects the pixel difference between a target field and a neighboring field, and compares the detected pixel difference with a fixed threshold value, to determine whether the field has field motion phenomenon.

However, there are many differences between image data at different time points in time domain. Thus, using the fixed threshold value to perform the motion detection for the image data at different time points usually causes detection errors. In addition, the amount of noise of the image data also affects the accuracy of the motion detection. Because the results of the motion detection seriously influence the efficiency of the following image processing operations (e.g., de-interlacing), it is a necessary to increase the accuracy and the reliability of the motion detection.

### SUMMARY OF THE INVENTION

It is an objective of the claimed invention to provide methods and related apparatuses for the motion detection to solve the above-mentioned problems.

According to one embodiment of the claimed invention, a method for motion detection is disclosed. The method comprises: detecting at least one field to generate a plurality of statistical values; determining at least one threshold value according to the plurality of statistical values; and performing motion detection on pixel positions of a subsequent field according to the determined threshold value.

According to one embodiment of the claimed invention, a motion detection apparatus comprises: a detection module for performing detection on at least one field to generate a plurality of statistical values; a decision unit, coupled to the detection module, for determining at least one threshold value according to the plurality of statistical values; and a motion detection module, coupled to the decision unit, for performing motion detection on pixel positions of a subsequent field according to the threshold value determined by the decision unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified block diagram of a motion detection apparatus according to a first embodiment of the present invention.

FIG. 2 illustrates a flowchart of a motion detection method according to one embodiment of the present invention.

FIG. 3 is a flowchart of operations of the comparison module shown in FIG. 1 according to one embodiment of the present invention.

FIG. 4 is a diagram of a target field.

FIG. 5 is a simplified block diagram of a motion detection apparatus according to a second embodiment of the present invention.

### DETAILED DESCRIPTION

Different characteristics of the present invention are described with the accompanying figures, and similar components are labeled with the same notation in the figures. Please note that motion detection apparatuses and related methods disclosed in various embodiments of the present invention are applicable to many image processing operations such as motion adaptive de-interlacing, motion compensation de-interlacing, Y/C separation, false color suppression, and noise reduction. Additionally, in practice, the term “pixel value” in related descriptions of the claimed invention can be utilized for representing pixel luminance, pixel chrominance, or any other value capable of being utilized for motion detection, while the term “pixel position” covers a wide range, and can be utilized for defining a position of an existing pixel or a position of a pixel having a pixel value to be generated through interpolation.

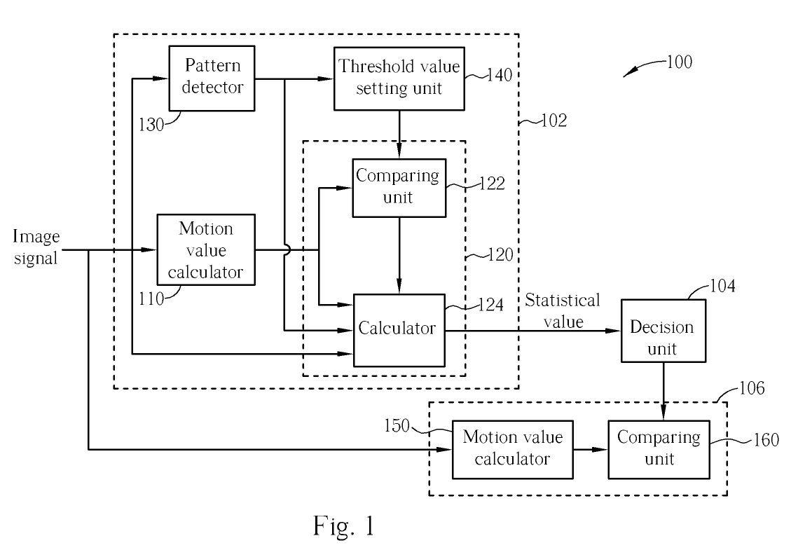

Please refer to FIG. 1. FIG. 1 is a simplified block diagram of the motion detection apparatus 100 according to a first embodiment of the present invention. The motion detection apparatus 100 includes a detection module 102, a decision unit 104, and a motion detection module 106. As shown in FIG. 1, the detection module 102 includes a motion value calculator 110, a statistical unit 120, and a pattern detector 130, where the statistical unit 120 includes a comparing unit 122 and a calculator 124. The motion detection module 106 can be implemented by utilizing a field motion detector, a frame motion detector, or a combination of both. In this embodiment, the motion detection module 106 includes a motion value calculator 150 and a comparing unit 160.

The images at adjacent time points in time domain are usually similar to each other. Therefore, the motion detection apparatus 100 utilizes the detection module 102 to detect one or more fields, and further utilizes the decision unit 104 to analyze detection results from the detection module 102, in order to dynamically adjust a threshold value utilized for performing motion detection on a subsequent frame by the motion detection module 106. In other words, the motion detection apparatus 100 can adaptively adjust the threshold value utilized for motion detection to increase the accuracy of the motion detection.

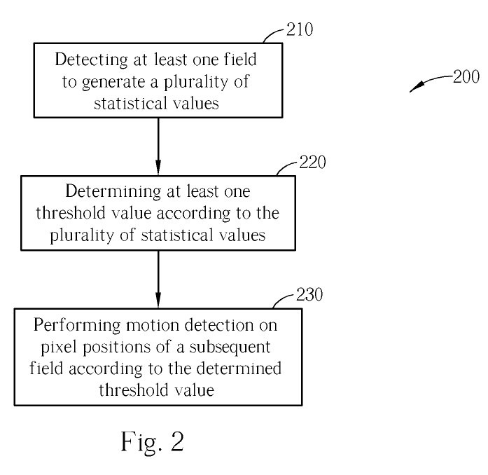

FIG. 2 is a flowchart 200 of a motion detection method according to one embodiment of the present invention. Operations of the motion detection apparatus 100 are further described accompanying with the flowchart 200 as follows.

In Step 210, the detection module 102 receives an image signal such as a video signal, and detects at least one field of the image signal to generate a plurality of statistical values. In practice, the number of statistical values generated by the detection module 102 can be determined according to system design considerations, and is not limited to utilizing a specific number.

In Step 220, the decision unit 104 determines at least one threshold value according to the plurality of statistical values.

And in Step 230, the motion detection module 106 performs the motion detection on pixel positions of a subsequent field according to the threshold value determined by the decision unit 104. In practice, the motion detection performed by the motion detection module 106 can be the field motion detection, the frame motion detection, or both.

In the first embodiment, in Step 210, the detection module 102 utilizes the motion value calculator 110 to calculate a motion value of each pixel position within a target field, in order to generate a plurality of first motion values. When performing the field motion detection or the frame motion detection on a specific pixel position, a pixel difference between the fields or a pixel difference between the frames regarding the specific pixel position is calculated first, so as to be a motion value of the specific pixel position. Then, the motion value is compared with the predetermined threshold value to determine whether the specific pixel position has field motion or the frame motion. In this embodiment, the methods for calculating each first motion value by motion value calculator 110 are substantially the same as the above-mentioned methods for calculating the motion value of the specific pixel position, and therefore, the detailed illustration is omitted for brevity.

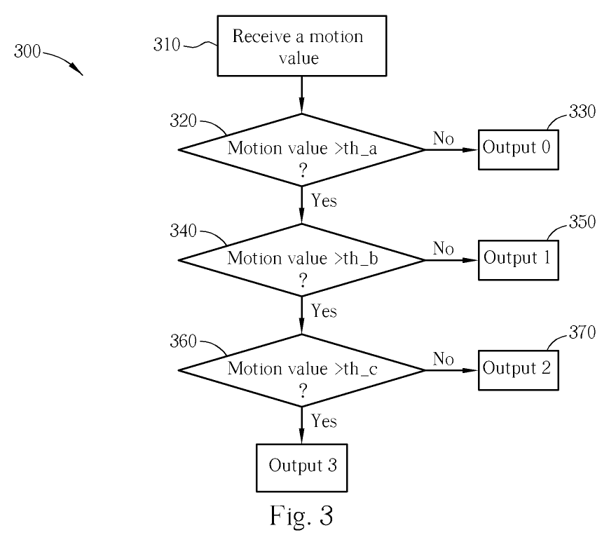

The comparing unit 122 in the statistical unit 120 respectively compares the plurality of first motion values with the plurality of predetermined values to correspondingly generate a plurality of decision values. FIG. 3 is a flowchart 300 of operations of the comparing unit 122 according to one embodiment. In this embodiment, when the comparing unit 122 receives the motion value of a pixel position (in Step 310), the motion value is compared with three predetermined threshold values th_a, th_b, and th_c (in Step 320, 340, and 360, respectively), where th_a<th_b<th_c. If the motion value is less than or equal to the threshold value th_a, the comparing unit 122 outputs 0 as the decision value of the pixel position (Step 330). If the motion value falls between the threshold values th_a and th_b, the comparing unit 122 outputs 1 as the decision value of the pixel position (Step 350). If the motion value falls between the threshold values th_b and th_c, the comparing unit 122 outputs 2 as the decision value of the pixel position (Step 370). If the motion value is greater than the threshold value th_c, the comparing unit 122 outputs 3 as the decision value of the pixel position (Step 380). Please note that, the order of operations of the steps in the flowchart 300 can be varied according to variations of this embodiment.

Then, the calculator 124 in the statistical unit 120 calculates the number of pixel positions of the target field with the decision value 1 as a first statistical value SMP, and calculates the number of pixel positions of the target field with the decision value 2 or the decision value 3 as a second statistical value LMP. In addition, the calculator 124 calculates the degree of pixel value variation as a third statistical value VL. In practice, the degree of the pixel value variance of the target field can be measured by the change rate, standardized change rate, variance, coefficient of variance CV, or other statistical values of the pixel values of the target field.

In this embodiment, in Step 220, the decision unit 104 sets the threshold value utilized for performing the motion detection of the subsequent field by the motion detection module 106 according to the statistical values SMP, LMP, and VL generated from the statistical unit 120. For example, if the sum of the statistical values SMP and LMP is greater than a first threshold value th_1, the statistical value SMP is greater than a second threshold value th_2 (or greater than the statistical value LMP), and the statistical value VL is greater than a third threshold value th_3, the decision unit 104 determines that the target field has many noises, and increases the threshold value utilized for performing the motion detection on the subsequent field by the motion detection module 106 or directly sets the threshold value as a greater value, to decrease the probability of misjudgments due to the noise.

Additionally, if the statistical values SMP, LMP, and VL do not satisfy the aforementioned conditions, the decision unit 104 can set the threshold value utilized by the motion detection module 106 according to the magnitude of the first statistical value SMP. When the first statistical value SMP becomes smaller, the target field has fewer noises (i.e., the image signal of the target field is clearer). Therefore, the decision unit 104 decreases or sets the threshold value utilized by the motion detection module 106 as a smaller value.

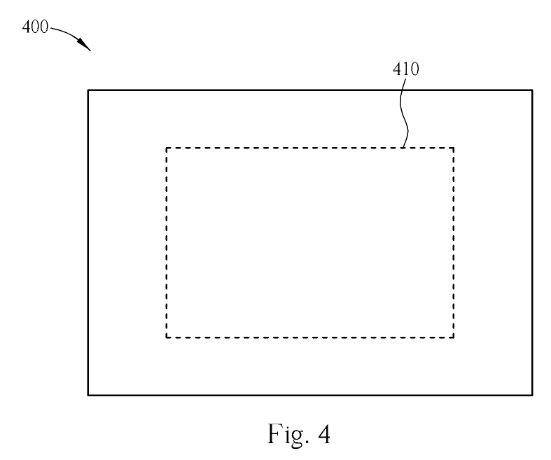

In a second embodiment, in Step 210, the calculator 124 further calculates a fourth statistical value FDS_C. FIG. 4 is a diagram of a target field 400. A central region 410 of the target field 400 represents a more sensitive visual region than others for human eyes, where the size and the shape of the central region 410 can be determined by a system designer according to different variations of this embodiment, and are not limited to being implemented strictly according to the embodiment shown in FIG. 4. As mentioned before, the motion value calculator 110 calculates the motion values of all the pixel position in the target field 400 to generate the plurality of first motion values. In this embodiment, the calculator 124 calculates the sum of the first motion values corresponding to all the pixel positions in the central region 410 of the target field, or calculates the sum of the pixel positions with the decision value 3 in the central region 410, as the fourth statistical value FDS_C. The fourth statistical value FDS_C represents the motion conditions of the central region 410 of the target field 400. The smaller the fourth statistical value FDS_C, the higher the still image ratio in the more sensitive visual region of the target field 400 is, where the still image ratio here is defined as a ratio of the area of still image(s) to the whole area of the more sensitive visual region. On the contrary, the greater the fourth statistical value FSD_C, the higher the dynamic image ratio in the more sensitive visual region of the target field 400 is, where the dynamic image ratio here is defined as a ratio of the area of dynamic image(s) to the whole area of the more sensitive visual region.

In this embodiment, in Step 220, the decision unit 104 also decides the threshold value utilized by the motion detection module 106 according to the fourth statistical value FDS_C. For example, the statistical values SMP, LMP, and VL do not satisfy the three conditions comprising: the sum of SMP and LMP is greater than th_1; SMP is greater than th_2; and VL is greater than th_3. In this situation, if the fourth statistical value FDS_C is greater than a fourth threshold value th_4, the decision unit 104 sets the threshold value utilized by the motion detection module 106 as a smaller value, to make it possible for the motion detection module to detect all the pixel position with image motion in the central region of the target field 400. In addition, if the fourth statistical value FDS_C is less than or equal to the fourth threshold value th_4, the decision unit 104 sets the threshold value utilized by the motion detection module 106 according to the magnitude of the first statistical value SMP.

In a third embodiment, the calculator 124 also calculates the sum of the first motion values corresponding to all the pixel positions in the target field, or calculates the number of the pixel positions with decision value 3 within the target field 400, as the fifth statistical value FDS. In this embodiment, only when the fourth statistical value FDS_C reaches a predetermined ratio of the fifth statistical value FDS, the fourth statistical value FDS_C is involved in considerations for operations performed by the decision unit 104.

In a fourth embodiment, the calculator 124 also calculates the sum of the plurality of decision values which is outputted from the comparing unit 122 and corresponding to the target field as a sixth statistical value TMSum, and calculates the sum of decision values having the value 2 or the value 3 within the plurality of decision values as a seventh statistical value LMSum. As mentioned above, the decision unit 104 sets the threshold value used by the motion detection module 106 according to the first statistical value SMP. In this embodiment, the decision unit 104 can also determine whether the image of the target field is a zooming image or a slow motion image according to the sixth statistical value TMSum and the seventh statistical value LMSum. Furthermore, if the seventh statistical value LMSum reaches a specific ratio of the sixth statistical value TMSum, the decision unit 104 determines the target field as the zooming image or the slow motion image. At this situation, the decision unit 104 decreases the aforementioned threshold value determined according the first statistical value SMP, to increase the probability that the pixel positions within the target field are determined to have image motion.

In practice, the detection module 102 can also detect the number of the pixel positions corresponding to high frequency components in the target field, so the decision unit 104 may tune the threshold value determined from the above embodiment(s) according to the number of pixel positions. For example, in a fifth embodiment, the pattern detector 130 in the detection module 102 performs pattern detection on all the pixel positions of the target field. And the calculator 124 in the statistical unit 120 calculates the number of the pixel positions corresponding to specific pattern(s) determined by the pattern detector 130 as an eighth statistical value MHP. There are many methods for performing the pattern detection on a specific pixel position. For example, Sobel mask (i.e. Sobel filter) or Laplace mask (i.e. Laplace filter) can be utilized for detecting the edge pattern of the specific pixel position. Other methods for detecting image patterns at specific pixel positions can also be applied to the pattern detector 130 of this embodiment. In this embodiment, the pattern detector 130 is capable of determining whether a pixel position corresponds to a certain image pattern such as a horizontal edge pattern or a mess pattern, so the calculator 124 may calculate the number of pixel positions corresponding to the horizontal edge pattern or the mess pattern in the target field, and the number of pixel position is regarded as the eighth statistical value MHP.

The greater the eighth statistical value MHP, the more pixel positions correspond to high frequency components. The decision unit 104 can slightly increase the threshold value determined by the method according to the previous embodiment, to decrease the probability of misjudgment made by the motion detection module 106. On the contrary, in the case that the eighth statistical value MHP is smaller, the decision unit 104 can slightly decrease the threshold value determined by the method according to the previous embodiment.

In the previous embodiment, the comparing unit 122 of the statistical unit 120 compares the received motion values and the plurality of predetermined threshold values (i.e. the predetermined threshold values th_a, th_b, and th_c in this embodiment,) to correspondingly generate decision values, respectively. In one embodiment, as shown in FIG. 1, the detection module 102 further includes a threshold value setting unit 140, which is utilized for dynamically adjusting the plurality of predetermined threshold values utilized by the comparing unit 122 according to the detection results from the pattern detector 130. For example, in a region where the pattern detector 130 determines as the mess pattern, the threshold value setting unit 140 can properly increase the plurality of predetermined threshold values utilized by the comparing unit 122. On the contrary, in a region where the pattern detector 130 determines as the smooth pattern, the threshold value setting unit 140 can properly decrease the plurality of predetermined threshold values utilized by the comparing unit 122. Therefore, the accuracy of the decision values outputted from the comparing unit 122 can be increased.

In Step 230, the motion detection module 106 performs the motion detection on the pixel positions of the subsequent field of the target field according to the threshold value determined by the decision unit 104. In the embodiment shown in FIG. 1, the motion detection module 106 calculates the motion values of all the pixel positions in the subsequent field by utilizing the motion value calculator 150, to generate a plurality of second motion values. Then the comparing unit 160 respectively compares the plurality of second motion values with the threshold value determined by the decision unit 104, to determine whether image motion exists at any of the pixel positions in the subsequent field.

In practice, the functional blocks of the motion detection apparatus 100 can be implemented by utilizing individual circuit components. In addition, a portion or all of the functional blocks of the motion detection module 100 can also be integrated into a single chip. For example, the structure and the operation method of the motion value calculator 150 are quite similar to those of the motion value calculator 110 of the detection module 102, where the only difference between them is that the processed image signals correspond to difference time points. Therefore, in practice, the motion value calculator 150 and the motion value calculator 110 can be implemented by utilizing the same circuit to save hardware costs.

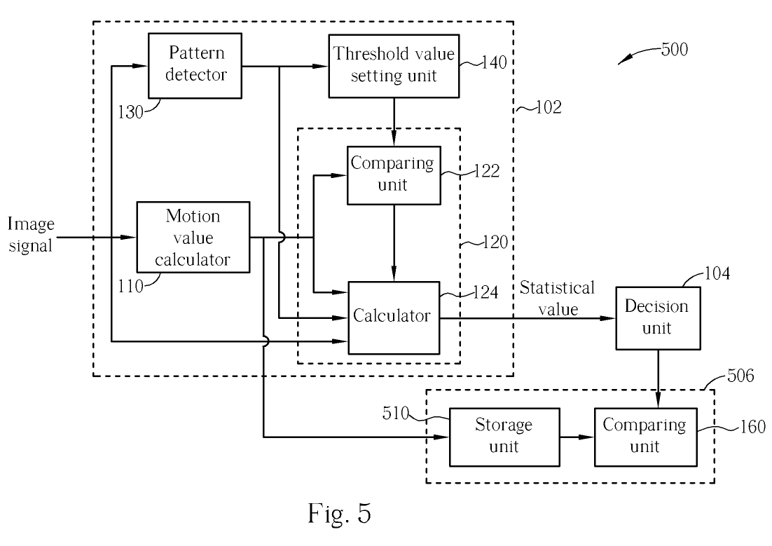

Please refer to FIG. 5. FIG. 5 is the simplified block diagram of the motion detection apparatus 500 in the second embodiment of the present invention. As shown in FIG. 5, the motion detection module 506 of the motion detection apparatus 500 is implemented by utilizing a storage unit 510 accompanying with the comparing unit 160. After calculating the plurality of first motion values corresponding to the target field, the motion value calculator 110 of the detection module 102 further calculates the motion values of all the pixel positions in the next field to generate the plurality of second motion values. Therefore, the motion detection module 506 can temporarily store the motion values outputted from the motion value calculator 110 by utilizing the storage unit 510, and does not need to perform the same calculations of the motion value calculator 110. For example, the plurality of second motion values generated by the motion values calculator 110 can be temporarily stored in the storage unit 510. When the decision unit 104 determines the threshold value, which is utilized by the motion detection module 506 to perform the motion detection in the subsequent field of the target field, the motion detection module 506 only needs to respectively compare the plurality of second motion values temporarily stored in the storage unit 510 with the threshold value determined by the decision unit 104, by utilizing the comparing unit 160. From the comparison results, whether image motion exists at any of all the pixel positions of the subsequent field can be determined. Consequently, the amount of operations of the motion detection apparatus 500 can be greatly decreased.

Those skilled in the art will readily observe that numerous modifications and alterations of the device and method may be made while retaining the teachings of the invention.

What is claimed is:

1. A method for motion detection, comprising:
detecting at least one field to generate a plurality of statistical values;
determining at least one threshold value according to the plurality of statistical values; and
performing motion detection on pixel positions of a subsequent field according to the determined threshold value.

2. The method of claim 1, wherein the motion detection comprises at least one of a field motion detection and a frame motion detection.

3. The method of claim 1, wherein the step of generating the plurality of statistical values comprises:
calculating a plurality of first motion values corresponding to a plurality of pixel positions of the field; and
generating at least one statistical value according to the plurality of first motion values.

4. The method of claim 3, wherein the step of performing the motion detection on the pixel positions of the subsequent field comprises:
calculating a plurality of second motion values corresponding to a plurality of pixel positions of the subsequent field; and
comparing the plurality of second motion values with the determined threshold value to respectively determine whether image motion exists at the plurality of pixel positions of the subsequent field.

5. The method of claim 3, wherein the step of generating at least one statistical value according to the plurality of first motion values comprises:
respectively comparing the plurality of the first motion values with a plurality of predetermined threshold values to correspondingly generate a plurality of decision values; and
calculating the statistical value according to the plurality of decision values.

6. The method of claim 5, further comprising:
performing pattern detection on the at least one field; and
dynamically adjusting the plurality of predetermined threshold values according to results of the pattern detection.

7. The method of claim 4, wherein the step of generating the statistical value according to the plurality of first motion values comprises:
calculating a sum of the plurality of first motion values as the statistical value.

8. The method of claim 3, wherein the step of generating the statistical value according to the plurality of first motion values comprises:
calculating a sum of first motion values corresponding to pixel positions within the central area of the field as the statistical value.

9. The method of claim 1, wherein the step of generating the plurality of statistical values comprises:
calculating the degree of pixel value variation of the field as one of the plurality of statistical values.

10. The method of claim 1, wherein the step of generating the plurality of statistical value comprises:
detecting a number of pixel positions corresponding to high frequency components within the field as one of the plurality of statistical values.

11. The method of claim 10, wherein the step of detecting the number of the pixel positions corresponding to the high frequency components within the field comprises:
performing pattern detection on the field; and
calculating a number of pixel positions corresponding to specific pattern(s) determined by the pattern detection as one of the plurality of statistical values.

12. The method of claim 1, wherein the step of generating the plurality of statistical values comprises:
calculating a plurality of first motion values corresponding to a plurality of pixel positions of the field;
respectively comparing the plurality of first motion values with a plurality of predetermined threshold values to correspondingly generate a plurality of decision values;
calculating a number of pixel positions corresponding to a first decision value of the plurality of decision values as a first statistical value;
calculating the number of pixel positions corresponding to a second decision value or a third decision value of the plurality of the decision values as a second statistical value; and
calculating the degree of pixel value variation of the field as a third statistical value.

13. The method of claim 12, wherein the step of generating the plurality of statistical values further comprises:
calculating a sum of first motion values corresponding to pixel positions within a central area of the field as a fourth statistical value.

14. A motion detection apparatus, comprising:
a detection module for performing detection on at least one field to generate a plurality of statistical values.
a decision unit, coupled to the detection module, for determining at least one threshold value according to the plurality of statistical values; and
a motion detection module, coupled to the decision unit, for performing motion detection on pixel positions of a subsequent field according to the threshold value determined by the decision unit.

15. The motion detection apparatus of claim 14, wherein the motion detection module comprises at least one of a field motion detector and a frame motion detector.

16. The motion detection apparatus of claim 14, wherein the detection module comprises:
a motion value calculator for calculating a plurality of first motion values corresponding to a plurality of pixel positions of the field; and
a statistical unit, coupled to the motion value calculator, for generating at least one statistical value according to the plurality of first motion values.

17. The motion detection apparatus of claim 16, wherein the motion value calculator further calculates a plurality of second motion values corresponding to a plurality of the pixel positions of the subsequent field, and the motion detection module comprises:
a storage unit, coupled to the motion value calculator, for storing the plurality of second motion values; and
a comparing unit, coupled to the storage unit, for respectively comparing the plurality of second motion value with the threshold value determined by the decision unit, to respectively determine whether image motion exists at the plurality of pixel positions of the subsequent field.

18. The motion detection apparatus of claim 16, wherein the statistical unit comprises:
a comparing unit, for respectively comparing the plurality of first motion values with a plurality of predetermined threshold values to correspondingly generate a plurality of decision values; and
a calculator, for calculating the statistical value according to the plurality of decision values.

19. The motion detection apparatus of claim 16, further comprising:
a pattern detector, for performing pattern detection on the at least one field; and
a threshold value setting unit, coupled to the pattern detector and the comparing unit, for dynamically adjusting the plurality of predetermined threshold values according to detection results of the pattern detector.

20. The motion detection apparatus of claim 16, wherein the statistical unit calculates a sum of the plurality of first motion values as the statistical value.

21. The motion detection apparatus of claim 16, wherein the statistical unit calculates a sum of first motion values corresponding to pixel positions within a central area of the field as the statistical value.

22. The motion detection apparatus of claim 14, wherein the detection module calculates the degree of pixel value variation of the field as one of the plurality of statistical values.

23. The motion detection apparatus of claim 14, wherein the detection module detects the number of pixel positions corresponding to high frequency components within the field as one of the plurality of statistical values.

24. The motion detection apparatus of claim 23, wherein the detection module comprises:
a pattern detector, for performing pattern detection on the field; and
a statistical unit, coupled to the pattern detector, for calculating the number of pixel positions corresponding to specific pattern(s) determined by the pattern detector as one of the plurality of statistical values.

25. The motion detection apparatus of claim 14, wherein the detection module comprises:
a motion value calculator, for calculating a plurality of first motion values corresponding to a plurality of pixel positions of the field;
a comparing unit, for respectively comparing the plurality of first motion values with a plurality of predetermined threshold values to correspondingly generate a plurality of decision values; and
a calculator, for calculating a number of pixel positions corresponding to a first decision value of the plurality of decision values as a first statistical value, calculating the number of pixel positions corresponding to a second decision value or a third decision value of the plurality of decision values as the second statistical value, and calculating the degree of pixel value variation of the field as a third statistical value.

26. The motion detection apparatus of claim 25, wherein the calculator further calculates the sum of first motion values corresponding to pixel positions within a central area of the field as a fourth statistical value.
